(19) United States
(12) Patent Application Publication
(10) Pub. No.: US 2022/0180221 A1
(43) Pub. Date: Jun. 9, 2022

(54) AUGMENTING A PRESENTATION BASED ON A PREDICTED USER KNOWLEDGE BACKGROUND

(71) Applicant: International Business Machines Corporation, Armonk, NY (US)

(72) Inventors: Qi Feng HUO, Beijing (CN); Jing Yan MA, Beijing (CN); Rui Li XU, Beijing (CN); Da Li LIU, Beijing (CN); Yuan Yuan WANG, Beijing (CN); Yan Song LIU, Beijing (CN); Lei LI, Beijing (CN)

(21) Appl. No.: 17/111,120

(22) Filed: Dec. 3, 2020

(51) Int. Cl. G06N 5/04; G06N 20/00; G06F 11/34; G06F 11/30

(52) U.S. Cl. CPC G06N 5/04; G06F 11/3006; G06F 11/3438; G06N 20/00

(57) ABSTRACT

A method includes predicting, using a machine learning model and based on a received set of user interactions on keywords appearing in a presentation, a knowledge background of the user indicating the user's degree of understanding of the presentation. The method also includes generating, based on the predicted knowledge background, a message comprising a description of a keyword in the presentation and coordinates where the description is to be positioned in the presentation and communicating the message to a device of the user.

### BACKGROUND

The present invention relates to presentations, and more specifically, to augmenting presentations based on predicted user knowledge backgrounds.

### SUMMARY

According to one embodiment, a method includes predicting, using a machine learning model and based on a received set of user interactions on keywords appearing in a presentation, a knowledge background of the user indicating the user's degree of understanding of the presentation. The method also includes generating, based on the predicted knowledge background, a message comprising a description of a keyword in the presentation and coordinates where the description is to be positioned in the presentation and communicating the message to a device of the user. Other embodiments include an apparatus and a system that perform this method.

### BRIEF DESCRIPTION OF THE SEVERAL VIEWS OF THE DRAWINGS

FIG. 1 illustrates an example system;

FIG. 2 illustrates example components of the system of FIG. 1;

FIG. 3 illustrates an example message in the system of FIG. 1;

FIG. 4A illustrates an example presentation in the system of FIG. 1;

FIG. 4B illustrates an example presentation in the system of FIG. 1;

FIG. 4C illustrates an example presentation in the system of FIG. 1;

FIG. 5 is a flowchart of an example method in the system of FIG. 1; and

FIG. 6 is a flowchart of an example method in the system of FIG. 1.

### DETAILED DESCRIPTION

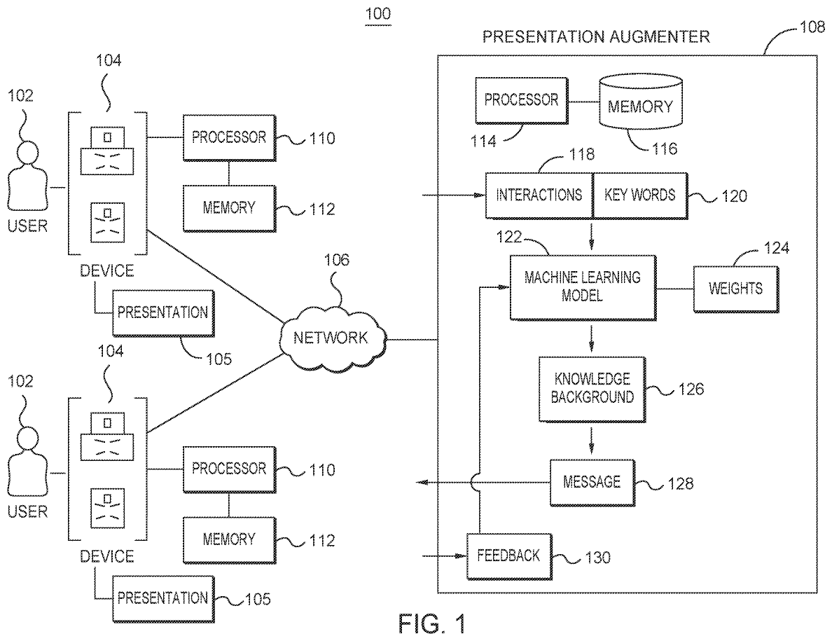

Presentations are delivered to audiences with people of different backgrounds and knowledge bases. For example, the audience may include people whose primary language is different from the language of the presentation and the presenter, which may impact these people's understanding of the presentation. As another example, the audience may include people who have different levels of background knowledge relating to the presentation, which may also impact these people's understanding of the presentation. This disclosure describes a system that predicts the knowledge and understanding of an audience member based on the audience member's interactions with keywords in the presentation (e.g., clicking on the word, focusing on the word, etc.) and that augments the presentation to include explanations or descriptions of certain keywords that might help the audience member's understanding of the presentation, in certain embodiments. The system will be described in more detail with respect to FIGS. 1 through 6.

With reference now to FIG. 1, which illustrates an example system 100. As seen in FIG. 1, the system 100 includes one or more devices 104, a network 106, and a presentation augmenter 108. Generally, the system 100 predicts a user's knowledge background based on actions taken by the user and then augments a presentation with explanations that augment or help the user's understanding of the presentation. In particular embodiments, the system 100 improves multiple users' understanding of a presentation, even if the users have diverse or different knowledge backgrounds.

A user 102 may use a device 104 to interact with other components of the system 100. For example, a user 102 may use the device 104 to interact with certain elements of a presentation 105 being displayed to the user 102 on the device 104. The device 104 may log the user's 102 interactions and communicate those interactions to the presentation augmenter 108. The device 104 may also receive messages from the presentation augmenter 108. The device 104 may process these messages to display explanations that help the user 102 understand the presentation 105. In certain embodiments, the messages may be generated based on a predicted knowledge background of the user 102. As seen in FIG. 1, the device 104 includes a processor 110 and a memory 112, which may be configured to perform any of the functions of the device 104 described herein.

The device 104 includes any suitable device for communicating with components of the system 100 over the network 106. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user 102. The device 104 may include a hardware processor, memory, or circuitry configured to perform any of the functions or actions of the device 104 described herein. For example, a software application designed using software code may be stored in the memory and executed by the processor to perform the functions of the device 104.

The processor 110 is any electronic circuitry, including, but not limited to microprocessors, application specific integrated circuits (ASIC), application specific instruction set processor (ASIP), and/or state machines, that communicatively couples to memory 112 and controls the operation of the device 104. The processor 110 may be 8-bit, 16-bit, 32-bit, 64-bit or of any other suitable architecture. The processor 110 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 110 may include other hardware that operates software to control and process information. The processor 110 executes software stored on memory to perform any of the functions described herein. The processor 110 controls the operation and administration of the device 104 by processing information (e.g., information received from the network 106, presentation augmenter 108, and memory 112). The processor 110 may be a programmable logic device, a microcontroller, a microprocessor, any suitable processing device, or any suitable combination of the preceding. The processor 110 is not limited to a single processing device and may encompass multiple processing devices. Insert standard text for the memory 112.

The memory 112 may store, either permanently or temporarily, data, operational software, or other information for the processor 110. The memory 112 may include any one or a combination of volatile or non-volatile local or remote devices suitable for storing information. For example, the memory 112 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 112, a disk, a CD, or a flash drive. In particular embodiments, the software may include an application executable by the processor 110 to perform one or more of the functions described herein.

The network 106 is any suitable network operable to facilitate communication between the components of the system 100. The network 106 may include any interconnecting system capable of transmitting audio, video, signals, data, messages, or any combination of the preceding. The network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

As seen in FIG. 1, the system 100 includes multiple users 102 and multiple devices 104. The users 102 may have different knowledge backgrounds. For example, the users 102 may have different levels of technical understanding that affect how the users 102 understand a presentation 105 being displayed to the users 102 on the devices 104. As another example, the users 102 may have different levels of fluency in the language of the presentation 105. These and several other factors may negatively impact the users' 102 understanding of the presentation 105. One user 102 may not understand the meaning of a set of words in the presentation 105 while another user 102 may not understand the meaning of a different set of words in the presentation 105. As a result, the users 102 may need different explanations to help the users 102 to understand the presentation 105.

Generally, the presentation augmenter 108 predicts the knowledge background of the user 102, based on interactions of the user 102 with the device 104 or the presentation 105. The system 100 then generates, based on the predicted knowledge background, messages that are suitable to help the user 102 understand the presentation 105. The device 104 may render explanations contained within these messages when the device 104 receives these messages.

The presentation augmenter 108 predicts the knowledge backgrounds of the users 102 in the system 100, and then generates messages that assist these users' 102 understanding of a presentation. As seen in FIG. 1, the presentation augmenter 108 includes a processor 114 and a memory 116, which are configured to perform any of the actions or functions of the presentation augmenter 108 described herein. In particular embodiments, the presentation augmenter 108 improves multiple users' 102 understanding of a presentation, even if these users 102 have diverse knowledge backgrounds.

The processor 114 is any electronic circuitry, including, but not limited to microprocessors, ASIC, ASIP, and/or state machines, that communicatively couples to memory 116 and controls the operation of the presentation augmenter 108. The processor 114 may be 8-bit, 16-bit, 32-bit, 64-bit or of any other suitable architecture. The processor 114 may include an ALU for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on memory to perform any of the functions described herein. The processor 114 controls the operation and administration of the presentation augmenter 108 by processing information (e.g., information received from the devices 104, network 106, and memory 116). The processor 114 may be a programmable logic device, a microcontroller, a microprocessor, any suitable processing device, or any suitable combination of the preceding. The processor 114 is not limited to a single processing device and may encompass multiple processing devices.

The memory 116 may store, either permanently or temporarily, data, operational software, or other information for the processor 114. The memory 116 may include any one or a combination of volatile or non-volatile local or remote devices suitable for storing information. For example, the memory 116 may include RAM, ROM, magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein.

The presentation augmenter 108 receives one or more interactions 118 of a user 102. The interactions 118 may be any suitable interaction that a user 102 has with the content of a presentation 105. For example, the interactions 118 may include a number of clicks that a user 102 has performed. As another example, the interactions 118 may include a frequency at which a user 102 performs clicks. As yet another example, the interactions 118 may include an amount of time that the user 102 hovered a mouse curser at a particular position. Furthermore, the interactions 118 may include an amount of time that a user 102 looked at a particular position in the presentation 105. For example, eye tracking software or technology may be used to track the eye movements of a user 102 looking at a presentation 105. The eye tracking software or tool may determine coordinates on the presentation 105 at which the user 102 is looking. The interactions 118 may also indicate an amount of time for which the user 102 looked at particular coordinates of the presentation 105.

The presentation augmenter 108 may also receive one or more keywords 120 from the devices 104. The keywords 120 may be the words on which the interactions 118 are performed. For example, the keywords 120 may indicate the words of the presentation 105 on which a user 102 clicked. As another example, the keywords 120 may indicate the words in the presentation 105 that the user 105 focused on or looked at. These words may be determined using the eye tracking software or tool.

In one embodiment, the presentation augmenter 108 implements a machine learning model 122 that predicts the knowledge background 126 of a user 102 based on the interactions 118 of the user 102 on the keywords 120. In particular embodiments, the machine learning model 122 may apply one or more weights 124 to the interactions 118 or the keywords 120 to predict the knowledge background 126 of a user 102. For example, the machine learning model 122 may apply the weights 124 to the interactions 118 or keywords 120 to produce a score for the user 102. The score may then be used to predict the knowledge background 126 of the user 102.

The knowledge background 126 for a user 102 may indicate the level of understanding of the user 102 of the presentation 105. For example, the knowledge background 126 may indicate a role for the user 102, which indicates a technical level of understanding. As another example, the knowledge background 126 may indicate a language proficiency of the user 102, which indicates how well the user 102 understands the presentation 105. As discussed previously, the knowledge background 126 may be predicted based on the interactions 118 of the user 102 on one or more keywords 120. For example, if a user 102 clicks on or looks at certain technical words in the presentation 105, then the presentation augmenter 108 may predict that the user 102 may have a role in which the user 102 does not understand the meanings of these words. As a result, the presentation augmenter 108 may predict a knowledge background 126 for the user 102 that indicates the user 102 does not understand these words. As another example, the presentation augmenter 108 may determine that the user 102 is clicking on, hovering over, or gazing at many different words in the presentation. As a result, the presentation augmenter 108 may predict that the user 102 has a language proficiency issue that hinders the user's 102 understanding of the presentation 105. The presentation augmenter 108 may then predict the knowledge background 126 that indicates the language proficiency issue of the user 102.

Presentation augmenter 108 generates a message 128 that includes explanations for particular words in the presentation 105 based on the knowledge background 126 of the user 102. For example, the message 128 may contain explanations for the meanings of certain words in the presentation 105. As another example, the message 128 may contain links to webpages that explain the meanings of certain words in the presentation 105. The presentation augmenter 108 may determine these words based on the predicted knowledge background 126 of the user 102 and the keywords 120. The presentation augmenter 108 may then communicate the message 128 to the device 104 of the user 102. The device 104 may then process the message 128 and render the included explanations for display to the user 102.

The presentation augmenter 108 may receive feedback 130 from the user 102. The feedback 130 may indicate how helpful certain explanations in the message 128 are to the user's 102 understanding of the presentation 105. For example, the feedback 130 may indicate whether the user 102 looked at or clicked on the explanation that was displayed on the device 104. As another example, the feedback 130 may indicate whether the user 102 closed or ignored the explanation that was displayed on the device 104. The presentation augmenter 108 may adjust the machine learning model 122 based on the feedback 130. For example, if the feedback 130 indicates that the user 102 clicked on or looked at an explanation in the message 128, the machine learning model 122 may be reinforced to present that explanation in messages 128 for subsequent users 102 that have the same knowledge background 126. As another example, if the feedback 130 indicates that the user 102 ignored or closed an explanation in the message 128, the presentation augmenter 108 may adjust the machine learning model 122 so that the message 128 does not include those explanations for subsequent users 102 that have the same knowledge background 126.

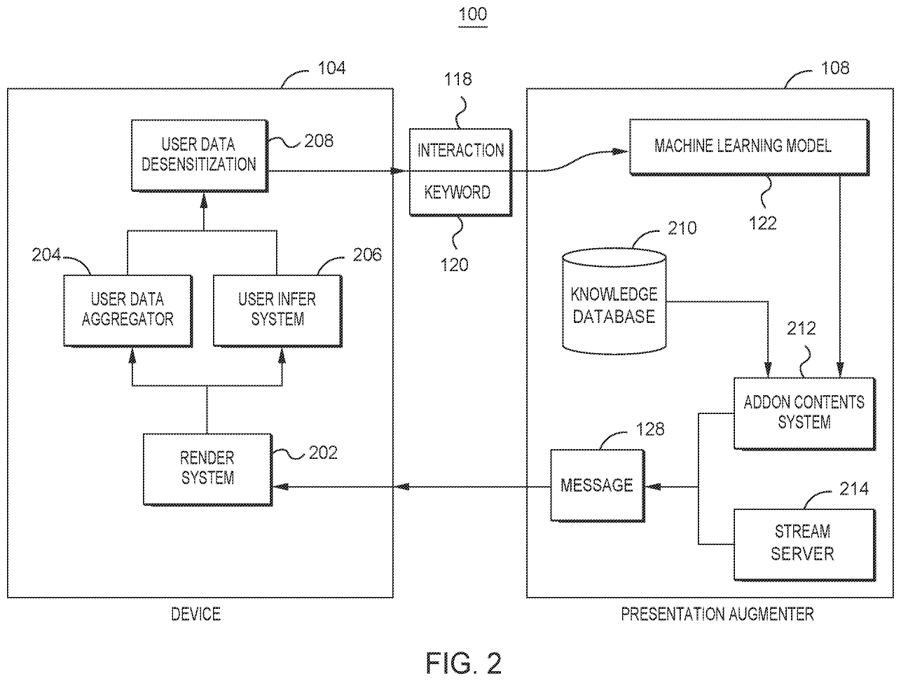

FIG. 2 illustrates example components of the system 100 of FIG. 1. As seen in FIG. 2, the system 100 includes a device 104 and a presentation augmenter 108. Generally, the device 104 provides user interaction data to the presentation augmenter 108. The presentation augmenter 108 processes this user interaction data to predict a knowledge background of the user. The presentation augmenter 108 then generates a message 128 that includes explanations suitable for the predicted knowledge background. In particular embodiments, the presentation augmenter 108 improves the user's 102 understanding of a presentation 105.

In the example of FIG. 2, the device 104 includes a render system 202, a user data aggregator 204, a user infer system 206, and a user data desensitization unit 208. Each of these components may be implemented using the processor 110 and memory 112 of the device 104. Generally, the render system 202 may render information provided to the device 104 for display. For example, the render system 202 may render explanations in the messages 128 for display on the device 104. As another example, the render system 202 may render presentations 105 for display on the device 104.

The user data aggregator 204 and the user infer system 206 may be used to determine the interactions 118 and keywords 120. For example, the user data aggregator 204 and the user infer system 206 may detect the keywords 120 that the user 102 clicks on, hovers over, or looks at. The user data aggregator 204 and the user infer system 206 may provide additional data, such as the number of times the user 102 clicks on a keyword 120, the amount of time that the user 102 hovers a mouse cursor over the keyword 120, or the amount of time that the user 102 looks at a keyword 120. As an example, the user data aggregator 204 may monitor a user's 102 behavior and collect the behavioral data, such as what coordinates on a display screen a user 102 looks at, clicks on, or hovers a mouse cursor over. The user infer system 206 may then determine the words in a presentation 105 that correspond to these coordinates. The user data aggregator 204 or the user infer system 206 may also collect information about the user 102. For example, the user data aggregator 204 or the user infer system 206 may collect usage statistics, language settings, time zones, and any other suitable information from a profile of the user 102 on the device 104.

The user data desensitization unit 208 removes sensitive information from the determined interactions 118 and keywords 120. For example, the user data desensitization unit 208 may remove personal information about the user 102 (e.g., usernames, device names, component names, etc.). In this manner, the user data desensitization unit 208 may protect the privacy of the user 102.

As discussed previously, the device 104 communicates the determined interactions 118 and keywords 120 to the presentation augmenter 108. The presentation augmenter 108 may process the interactions 118 and keywords 120 to predict the knowledge background 126 of the user 102. Then, the presentation augmenter 108 may generate a message 128 that includes explanations that may assist the user's 102 understanding of the presentation 105.

As seen in FIG. 2, the presentation augmenter 108 includes a knowledge database 210, an addon contents system 212, and a stream server 214. Each of these components may be implemented using the processor 114 and the memory 116 in the presentation augmenter 108. The knowledge database 210 may include information that is used to generate the message 128. For example, the knowledge database 210 may include the explanations or meanings of certain keywords 120. As another example, the knowledge database 210 may indicate the types of information that should be provided for different knowledge backgrounds 126.

The addon contents system 212 may receive the knowledge background 126 from the machine learning model 122 and information from the knowledge database 210. The addon content system 212 may then generate the appropriate information for the message 128 based on the information from the knowledge database 210 and the machine learning model 122. For example, the addon content system 212 may determine the keywords 120 that should be explained based on the knowledge background 126 predicted by the machine learning model 122 and the information from the knowledge database 210. The addon content system 212 may then generate explanations for these keywords 120 or links to webpages that explain these keywords 120 based on information stored within the knowledge database 210.

The stream server 214 forms the message 128 using the information provided by the addon content system 212. For example, the stream server 214 may generate the structure of the message 128 and include in that message 128 the explanations provided by the addon content system 212. The stream server 214 may generate and provide the message 128 as a stream to the device 104. This stream may be the same or different from a stream used by the device 104 to receive the presentation 105. After the message 128 is generated, the presentation augmenter 108 may communicate the message 128 to the render system 202 of the device 104. In certain embodiments, the presentation augmenter 108 may stream the message 128 to the render system 202 of the device 104.

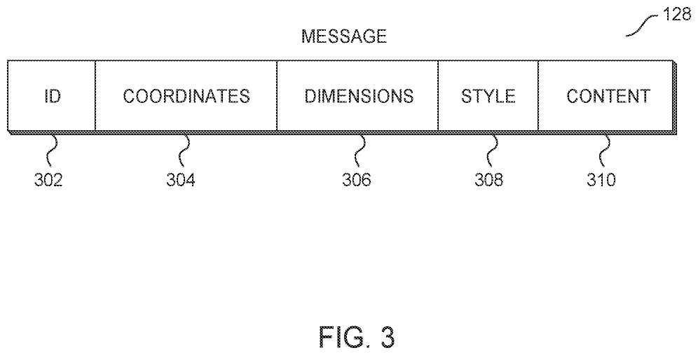

FIG. 3 illustrates an example message 128 in the system 100 of FIG. 1. As seen in FIG. 3, the message 128 includes an identifier 302, coordinates 304, dimensions 306, style 308, and content 310. Generally, the message 128 may be communicated to the device 104, so that the device 104 can display the content 310 in the message 128 according to the coordinates 304, dimensions 306, or style 308. The message 128 may be built upon messages of certain streaming protocols (e.g., the real-time messaging protocol). In particular embodiments, the message 128 assists a user's 102 understanding of a presentation of 105.

The identifier 302 may be an identifier of an application or the presentation 105. For example, the application may be presenting the presentation 105 on the device 104. The device 104 may use the identifier 302 to display the message 128 in the correct application or in the correct presentation 105.

The coordinates 304 may include coordinates for the position in the presentation 105 where the message 128 should be rendered or displayed. For example, the coordinates 304 may include X and Y positional coordinates. The device 104 may render the message 128 at the position indicated by the coordinates 304.

The dimensions 306 indicate the size of the message 128 when rendered. For example, the dimensions 308 may indicate the height and width of the rendered message. Larger dimensions 306 may cause the message 128 to be rendered as a large message 128. Smaller dimensions 306 may cause the message 128 to be rendered as a small message 128.

Styles 308 indicate any styles or formatting that should be applied to the message 128. For example, the styles 308 may indicate a font or a color to be used to render the message 128. Certain fonts or colors may be used to highlight or accentuate certain parts of the message 128.

The content 310 includes the explanations or links that were generated by the presentation augmenter 108. The device 104 may render the content 310 when rendering the message 128. The user 102 may view the content 310, and the content 310 may assist the users 102 understanding of the presentation 105.

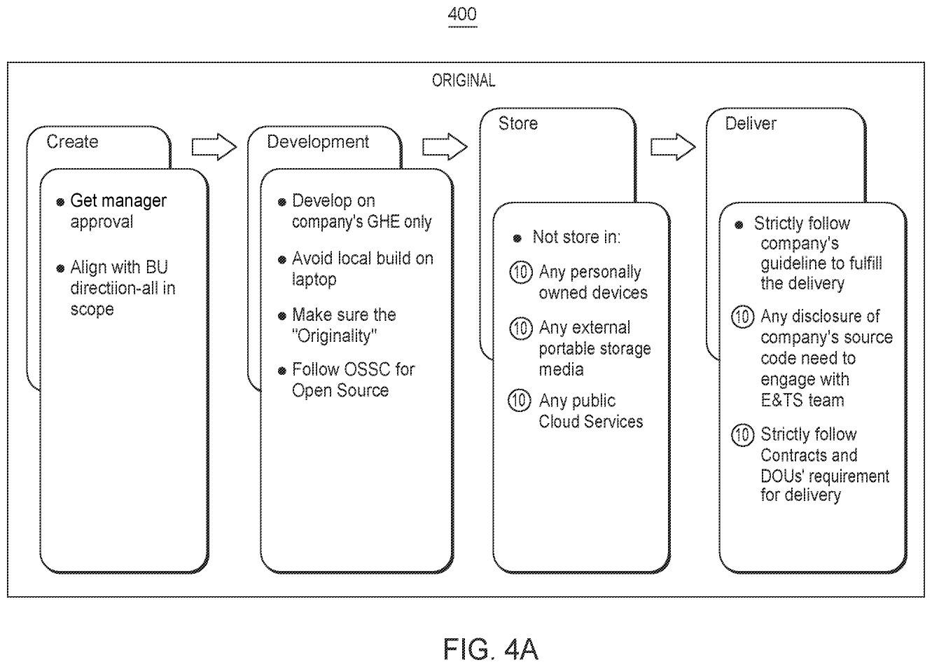

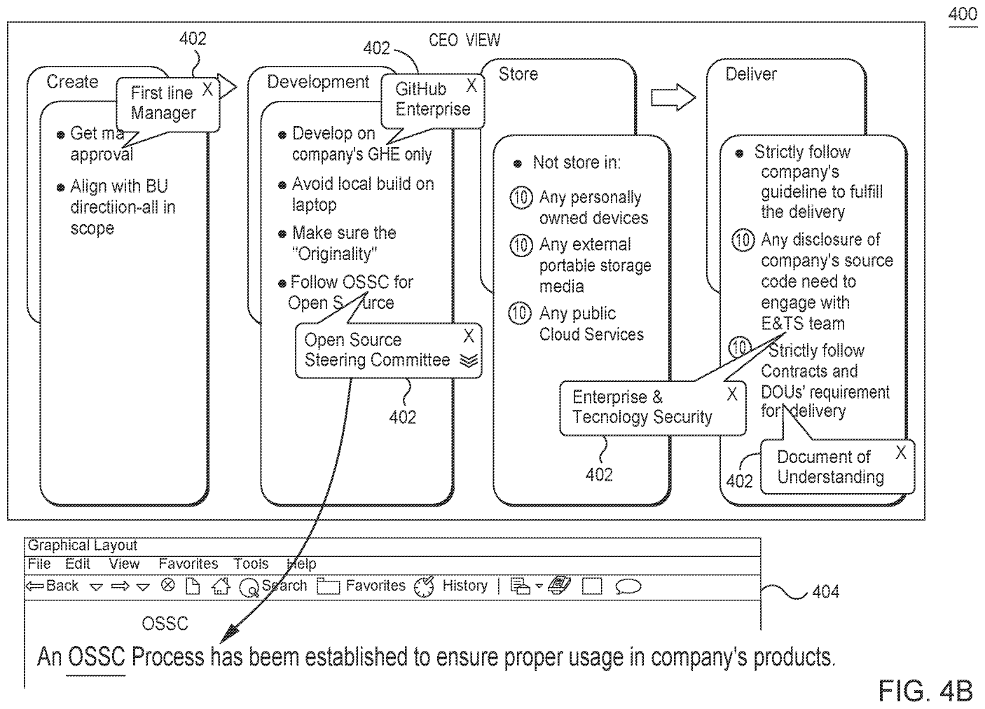

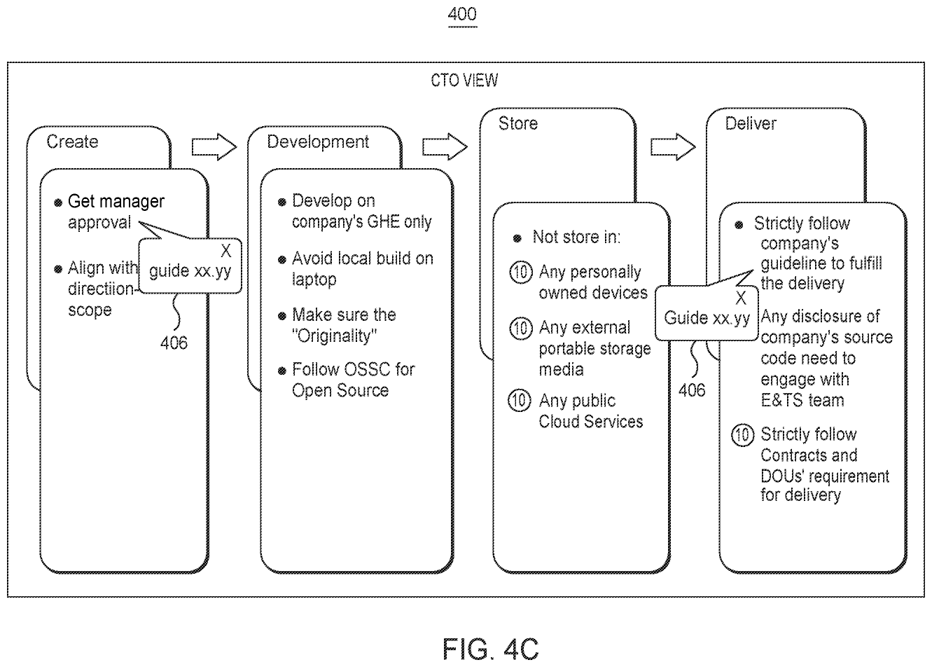

FIGS. 4A through 4C illustrate example slides 400 of a presentation 105 in the system 100 of FIG. 1. FIG. 4A illustrates the original slide 400, while FIGS. 4B and 4C illustrate the use of the slide 400 with explanations generated for different users 102. As seen in FIGS. 4A through 4C, the explanations generated for the slide 400 are different, depending on the predicted knowledge background 126 of the user 102.

FIG. 4A shows the original slide 400. As seen in FIG. 4A, the slide 400 includes several text boxes that include words. Some of these words are acronyms that may not be understood by every user viewing the slide 400. A user 102 viewing the slide 400 may interact with one or more words that the user 102 does not understand. For example, the user 102 may click on a word, hover a mouse cursor over the word, or look at the word for an extended period of time. The device 104 that displays the slide 400 may track the user's 102 interactions 118 with these words. The device 104 may then communicate these interactions 118 and words 120 to the presentation augmenter 108. Based on these interactions 118 and words 120, the presentation augmenter 108 may predict a knowledge background 126 for the user 102. The presentation augmenter 108 may then generate a message 128 that includes explanations for certain words 120 that may assist the user's 102 understanding of those words 120.

The predicted knowledge background 126 may include a predicted role of the user 102. The role may indicate a certain level of understanding of the user 102 of the presentation 105 or the slide 400. For example, if the user 102 is a chief executive officer (CEO), then the user 102 may experience difficulty understanding technical terms or acronyms within the slide 400. On the other hand, if the user 102 is a chief technical officer (CTO), then the user 102 may experience little difficulty understanding technical terms or acronyms within the slide 400. The presentation augmenter 108 may generate different messages 128 that include different explanations suitable for the different roles.

FIG. 4B illustrates a view of the slide 400 with rendered explanations for a CEO. As seen in FIG. 4B, the slide 400 includes several explanations 402 for different words in the slide 400. These explanations 402 may include explanations for certain technical acronyms within the slide 400 (e.g., GHE, OSSC, E&TS, and DOU). Additionally, the explanations 402 may include a link that redirects to a web page to explain one or more of these acronyms (e.g., OS SC). When the user 102 clicks on the link, the device 104 may open a webpage 404 that is the target of the link. In this manner, the presentation augmenter 108 and the device 104 provide and display explanations 402 that assist the user's 102 understanding of the slide 400.

FIG. 4C illustrates the slide 400 with explanations 406 rendered and displayed for a CTO. As discussed previously, the CTO may have a better understanding of the terms within the slide 400. As a result, the slide 400 that is generated for the CTO in FIG. 4C includes fewer explanations than the slide 400 generated for the CEO in FIG. 4B. Additionally, as seen in FIG. 4C, even if an explanation 406 is generated for the same word in the slide 400, the explanation 406 may be different from the corresponding explanation 402 in the FIG. 4B. This difference may be a result of the different predicted knowledge backgrounds 126 for the CEO and the CTO. As seen in the example of FIGS. 4B and 4C, the device 104 and presentation augmenter 108 may provide explanations 402 and 406 that are tailored for the particular user 102.

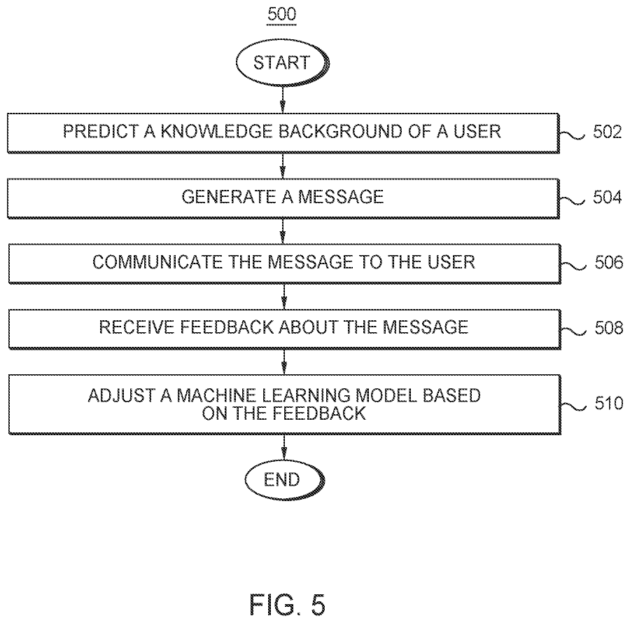

FIG. 5 is a flowchart of an example method 500 in the system 100 of FIG. 1. Generally, the presentation augmenter 108 performs the steps of the method 500. In particular embodiments, by performing the method 500 the presentation augmenter 108 improves a user's 102 understanding of a presentation 105.

In step 502, the presentation augmenter 108 predicts a knowledge background 126 of a user 102. The presentation augmenter 108 may use a machine learning model 122 to apply one or more weights 124 to interactions 118 and keywords 120 to predict the knowledge background 126 of a user 102. The device 104 may detect the interactions 118 and the keywords 120 and communicate the interactions 118 and keywords 120 to the presentation augmenter 108. For example, the device 104 may track the user's mouse cursor to determine whether the user 102 clicks on certain keywords 120 or hovers the mouse cursor over certain keywords 120. As another example, the device 104 may use eye tracking software or tools to track the user's 102 eyes. In this manner, the device 104 may determine the keywords 120 at which the user 102 is looking. The presentation augmenter 108 may apply weights 124 to the interactions 118 and keywords 120 to generate a score for the user 102. The machine learning model 122 may then use the score to predict the knowledge background 126 of the user 102.

In step 504, the presentation augmenter 108 generates a message 128 based on the predicted knowledge background 126. The message 128 may include explanations for certain keywords 120 that the presentation augmenter 108 predicts that the user 102 will have trouble understanding. The presentation augmenter 108 may generate the message 128 using information from a knowledge database 210. For example the knowledge database 210 may include information that indicates the words that should be explained for a particular knowledge background 126. Additionally, the knowledge database 210 may include the meanings of these words. The presentation augmenter 108 uses this information to build the message 128.

In step 506, the presentation augmenter 108 communicates the message 128 to the user 102 or the device 104. The device 104 may render the explanations in the message 128. In certain embodiments, the presentation augmenter 108 communicates the message 128 to the device 104 as a stream formed by the stream server 214. As discussed previously, the message 128 may include textual explanations of certain words. The message 128 may also include links to webpages 404 that help explain certain words.

The device 104 may render the explanations in the message 128 for display for the user 102. The user 102 may interact with one or more of these explanations that indicate whether these explanations were helpful to the user 102. For example, the user 102 may click on an explanation or look at an explanation, which indicates that the explanation is helpful to the user 102. As another example, the user 102 may ignore an explanation or close an explanation, which indicates that the explanation is not useful to the user 102. Based on these interactions with the explanations, the device 104 may generate feedback 130 for the presentation augmenter 108. The feedback 130 may indicate the interactions that the user 102 performed on the explanations in the message 128. In step 510, the presentation augmenter 108 adjusts the machine learning model 122 based on the feedback 130. For example, if the feedback 130 indicates that an explanation was helpful to the user 102, the presentation augmenter 108 may adjust the machine learning model 122 to provide the same explanation for a particular keyword 120 for subsequent users 102 that have the same knowledge background 126. As another example, if the feedback 130 indicates that an explanation was not helpful to the user 102, the presentation augmenter 108 may adjust the machine learning model 122 to not provide the same explanation for a particular keyword 120 to subsequent users 102 that have the same knowledge background 126.

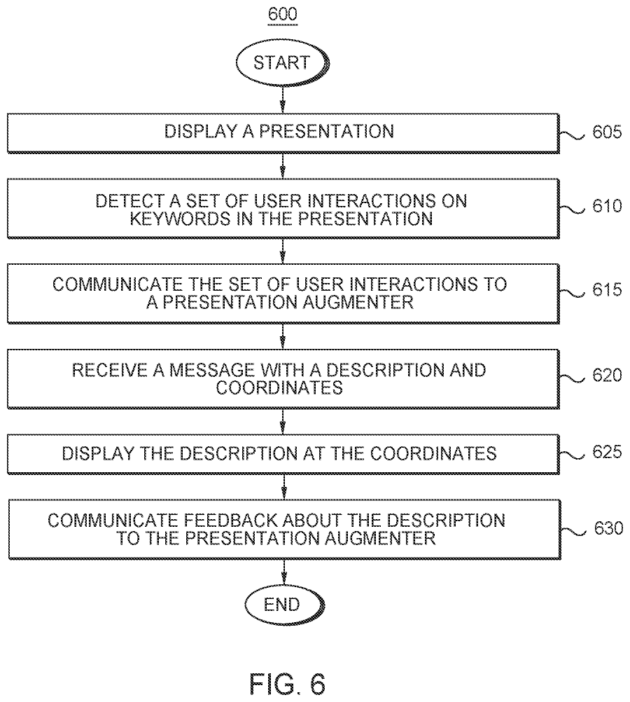

FIG. 6 is a flowchart of an example method 600 in the system 100 of FIG. 1. Generally, the device 104 performs the steps of the method 600. In particular embodiments, by performing the method 600, the device 104 improves a user's 102 understanding of a presentation 105.

In step 605, the device 104 displays a presentation 105. The presentation 105 may include words that a user 102 viewing the presentation 105 does not understand. For example, the user 102 may have a non-technical role or background and thus, may not understand certain technical words in the presentation 105. As another example, the user 102 may not be proficient in the language of the presentation 105 and thus, may struggle to understand words in the presentation 105.

In step 610, the device 104 detects a set of user interactions 118 on keywords 120 in the presentation 105. For example, the device 104 may detect that the user 102 clicks on certain keywords 120 in the presentation. As another example, the device 104 may use eye tracking technology to determine that the user 102 is gazing at certain keywords 120 in the presentation 105. Each of these interactions 118 may indicate that the user 102 is having difficulty understanding these keywords 120. In step 615, the device 104 communicates the set of user interactions 118 to a presentation augmenter 108. The presentation augmenter 108 includes a machine learning model 122 that predicts a knowledge background 126 of the user 102 based on the set of user interactions 118. The presentation augmenter 108 then generates descriptions for the keywords 120 based on the predicted knowledge background 126.

In step 620, the device 104 receives a message 128 from the presentation augmenter 108. The message 128 may include descriptions for keywords 120 and coordinates. In step 625, the device 104 displays the descriptions at the coordinates. The user 102 may then view the descriptions to better understand the presentation 105. For example, the descriptions may explain the meaning of certain keywords 120. As another example, the descriptions may include links to webpages that further explain the keywords 120. In step 630, the device 104 communicates feedback 130 about the description to the presentation augmenter 108. For example, the feedback 130 may indicate whether the user 102 clicked on a description or viewed a description, suggesting that the user 102 found the description to be helpful. As another example, the feedback 130 may indicate whether the user 102 closed the description or ignored the description, suggesting that the user 102 found the description to be unhelpful. The presentation augmenter 108 may adjust the machine learning model 122 based on the feedback 130.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
predicting, using a machine learning model and based on a received set of user interactions on keywords appearing in a presentation on a device of a user, a knowledge background of the user indicating the user's degree of understanding of the presentation;
generating, based on the predicted knowledge background, a message comprising a description of a keyword in the presentation and coordinates where the description is to be positioned in the presentation; and
communicating the message to the device.

2. The method of claim 1, further comprising determining a set of weights for the keywords based on a frequency at which the user clicks on the keywords.

3. The method of claim 1, further comprising determining a set of weights for the keywords based on a length of time the user looks at the keywords.

4. The method of claim 1, further comprising:
receiving feedback from the user about the description; and
adjusting the machine learning model based on the feedback.

5. The method of claim 4, wherein the feedback comprises whether the user clicked on the description, looked at the description, or hovered a cursor over the description.

6. The method of claim 4, wherein the feedback comprises whether the user ignored or closed the description.

7. The method of claim 1, wherein the message further comprises a dimension of the description.

8. An apparatus comprising:
a memory; and
a hardware processor communicatively coupled to the memory, the hardware processor configured to:
predict, using a machine learning model and based on a received set of user interactions on keywords appearing in a presentation on a device of a user, a knowledge background of the user indicating the user's degree of understanding of the presentation;
generate, based on the predicted knowledge background, a message comprising a description of a keyword in the presentation and coordinates where the description is to be positioned in the presentation; and
communicate the message to the device.

9. The apparatus of claim 8, the hardware processor further configured to determine a set of weights for the keywords based on a frequency at which the user clicks on the keywords.

10. The apparatus of claim 8, the hardware processor further configured to determine a set of weights for the keywords based on a length of time the user looks at the keywords.

11. The apparatus of claim 8, the hardware processor further configured to:
receive feedback from the user about the description; and
adjust the machine learning model based on the feedback.

12. The apparatus of claim 11, wherein the feedback comprises whether the user clicked on the description, looked at the description, or hovered a cursor over the description.

13. The apparatus of claim 11, wherein the feedback comprises whether the user ignored or closed the description.

14. The apparatus of claim 8, wherein the message further comprises a dimension of the description.

15. An apparatus comprising:
a memory; and
a hardware processor communicatively coupled to the memory, the hardware processor configured to:
display a presentation;
receive, from a user, a set of interactions on keywords appearing in the presentation;
communicate the set of interactions to a presentation augmenter;
receive, from the presentation augmenter, a message comprising a description of a keyword in the presentation and coordinates where the description is to be positioned in the presentation, the description based on a knowledge background of the user predicted based on the set of interactions; and
display the presentation with the description according to the coordinates.

16. The apparatus of claim 15, wherein the set of interactions comprises a frequency at which the user clicks on the keywords and wherein the knowledge background is predicted based on a set of weights determined based on the frequency.

17. The apparatus of claim 15, wherein the set of interactions comprises a length of time the user looks at the keywords, wherein the knowledge background is predicted based on a set of weights determined based on the length of time.

18. The apparatus of claim 15, the hardware processor is further configured to communicate feedback from the user about the description to the presentation augmenter, wherein a machine learning model used to predict the knowledge background is adjusted based on the feedback.

19. The apparatus of claim 18, wherein the feedback comprises whether the user clicked on the description, looked at the description, or hovered a cursor over the description.

20. The apparatus of claim 18, wherein the feedback comprises whether the user ignored or closed the description.
